(19) United States
(12) Patent Application Publication
(10) Pub. No.: US 2010/0104875 A1
(43) Pub. Date: Apr. 29, 2010

(54) MANUFACTURING METHOD FOR A PLUNGER AND SUCH A PLUNGER

(76) Inventors: Erhard Carls, Poppenricht/Trasslberg (DE); Helmut Kraus, Kummersbruck (DE); Stefan Langen, Kummersbruck (DE); Werner Olbrich, Muhlheim (DE); Wolfgang Schatz, Amberg (DE)

Correspondence Address: HARNESS, DICKEY & PIERCE, P.L.C., P.O.BOX 8910, RESTON, VA, 20195, US

(21) Appl. No.: 12/451,843

(22) PCT Filed: Aug. 24, 2007
(86) PCT No.: PCT/EP2007/058829

§ 371 Date: Dec. 3, 2009

(30) Foreign Application Priority Data
Jun. 29, 2007 (DE) 10 2007 030 391.4

(51) Int. Cl. B32B 9/00; H01H 9/14

(52) U.S. Cl. 428/411.1; 29/622; 29/884

(57) ABSTRACT

At least one embodiment of a plunger has, when viewed in a longitudinal direction, a central region and two outer regions adjoining the central region. The outer regions are injection-moulded from a non-magnetizable material. In the central region, a magnetizable material is integrated in the plunger. In at least one embodiment, an injection-mouldable material is used as the magnetizable material, and the plunger including the magnetizable material is manufactured by way of a two-component injection-moulding process. A defined magnetization is impressed on a section of the central region once the magnetizable material has been integrated in the plunger.

### PRIORITY STATEMENT

This application is the national phase under 35 U.S.C. §371 of PCT International Application No. PCT/EP2007/058829 which has an International filing date of Aug. 24, 2007, which designates the United States of America, and which claims priority on German patent application number DE 10 2007 030 391.4 filed Jun. 29, 2007, the entire contents of each of which are hereby incorporated herein by reference.

### FIELD

At least one embodiment of the present invention generally relates to a manufacturing method for a plunger which has, when viewed in a longitudinal direction, a central region and two outer regions adjoining the central region, with the outer regions of the plunger being injection-molded from a non-magnetizable material.

At least one embodiment of the present invention also generally relates to such a plunger.

### BACKGROUND

Plungers are used in electromagnetic switching devices and the like. In such a switching device the plunger is supported within a housing of the switching device so that it can move. It is able to be moved between two mechanical end positions, with the end positions of the plunger corresponding to the switching state of the switching device. The contact bridges (or comparable switching elements) of the switching device can be actuated by means of the plunger for example.

With switching devices—especially contactors—it is necessary in a plurality of applications to detect the actual switching state of the switching device—possibly by contrast with a control state of the switching device, to enable it to be evaluated differently.

Mechanical systems—compared to purely electronic systems—are as a rule relatively unreliable. It would thus be of advantage to be able to detect the switching position of the plunger in a non-contact manner.

In the older German patent application 10 2007 002 176.5, not as yet published on the application date of the present application, a detection device for non-contact detection of the switching position of a plunger is known. The plunger can in this case feature sections which are of different designs magnetically.

### SUMMARY

At least one embodiment of the present invention is directed to creating options which provide a basis for a plunger, of which the switching position is able to be detected in a non-contact manner, to be able to be produced in a simple way.

Inventively, in at least one embodiment the outer regions of the plunger will continue to be injection-molded from a non-magnetizable material. In the central region however a magnetizable material will be integrated into the plunger. A section of the central region will be impressed with a defined magnetization after the integration of the magnetizable material. An injection-moldable material can especially be used as a magnetizable material. In this case the plunger can be manufactured inclusive of the magnetizable material by way of a two-component injection molding method.

The injection-moldable magnetizable material can in particular be a magnetizable plastic. In particular ferrite particles can be mixed into the plastic.

It is possible for the section to be identical to the central region. Alternately it is possible for the section to only extend over a part of the central region.

### BRIEF DESCRIPTION OF THE DRAWINGS

Further advantages and details emerge from the subsequent description of example embodiments in conjunction with the drawings. The figures show the following basic diagrams:

FIG. 1 is a schematic diagram of the constructive design of a switching device and a detection device,

FIG. 2 is a schematic electrical block diagram of the detection device,

FIGS. 3 and 4 are two possible designs of plunger and

FIGS. 5 and 6 are two flow diagrams.

### DETAILED DESCRIPTION OF THE EXAMPLE EMBODIMENTS

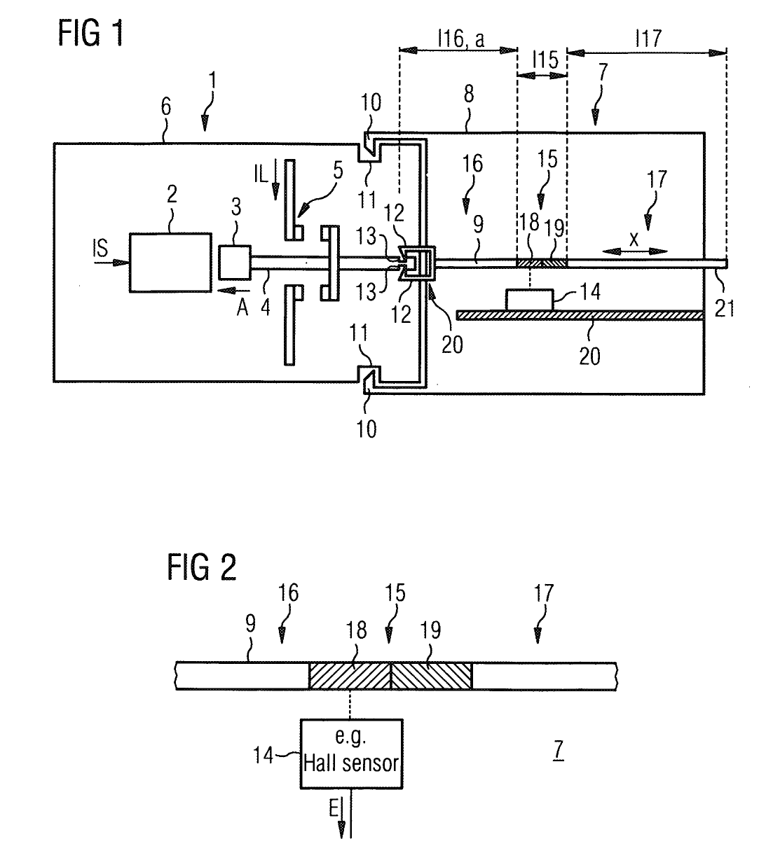

According to FIG. 1 an electromagnetic switching device 1 is embodied as a contactor. It features a coil 2 to which a switching current IS is able to be applied. When the switching current IS is applied to the coil 2, an armature 3 attracts. This is indicated in FIG. 1 by an arrow A. If the switching current IS is interrupted, the armature 3 moves away from the coil 2 because of a spring pressure which drives it back.

A plunger 4 is connected to the armature 3. Together with the armature 3, the plunger 4 is thus also attracted by the coil 2. As a result of the movement of the plunger 4 (at least) one load contact 5 is closed so that a load current IL can flow. Conversely, on interruption of the switching current IS, the load contact will be opened again.

As a rule the electromagnetic switching device 1 features a number of load contacts 5, for example three, four or five load contacts 5. The fact that FIG. 1 only shows a single load contact 5 merely serves to improve clarity.

The embodiment shown in FIG. 1 of the electromagnetic switching device is not the only possible embodiment. Alternately the electromagnetic switching device 1 could for example be embodied as a power switch. In this case the switching current IS is identical to the load current IL. The coil 2 attracts the armature 3 in this case when the load current IL becomes too large. Because of the attraction of the armature 3 a switching lock is released which moves the plunger 4 into a position in which the load contact 5 remains open.

Independent of the actual embodiment of the electromagnetic switching device 1, the electromagnetic switching device 1 has a housing 6 which surrounds the other above-mentioned elements 2 through 5 of the electromagnetic switching device 1. The position of the plunger 4 also corresponds independently of the actual embodiment of the electromagnetic switching device 1 to the switching device of the load contact 5 and thereby the switching status of the electromagnetic switching device 1.

To enable the switching status of the electromagnetic switching device 1 to be detected, a detection device 7 is present. The detection device 7, which will not be explained in any further detail below, can be a component of the electromagnetic switching device 1. As depicted in FIG. 1 however, it is embodied as an attachment for attaching to the electromagnetic switching device 1. According to FIG. 1 the detection device 7 thus features a housing 8 which is different from the housing 6 of the electromagnetic switching device 1. Furthermore the detection device 7 has a plunger 9 which is different from the plunger of the electromagnetic switching device.

In the present case, in which the detection device 7 is embodied as an attachment, the housing 8 of the detection device 7 can be fixed to the housing of the electromagnetic switching device 1. In FIG. 1 this is indicated by latching hooks 10 which are arranged on the housing of the detection device and which interact with latching cutouts 11 which are arranged on the housing 6 of the electromagnetic switching device 1. The fixing of the detection device 7 on the electromagnetic switching device 1 does not have to be via a latching connection however. It can alternately or additionally be fixed in another way, for example by means of screw connections.

The plunger 9 of the detection device 7 is supported in the housing 8 or the detection device 7 to allow movement. The plunger 9 of the detection device is able to be connected to the plunger 4 of the electromagnetic switching device 1. Here too latching hooks 12 can typically be arranged on the plunger 9 of the detection device 7, which interact with latching cutouts 13 arranged on the plunger of the electromagnetic switching device 1. Here too however another type of connection is possible. The decisive factor is that the plunger 9 of the detection device moves with the plunger 4 of the electromagnetic switching device 1.

In as far as the electromagnetic switching device 1 and the detection device 7 have been described thus far, the structure corresponds to the generally-known prior art structure. In particular the plunger 9 of the detection device 7 is movable between two mechanical end positions. Because of the connection of the plunger 9 of the detection device to the plunger 4 of the electromagnetic switching device 1 the end positions of the plunger 9 of the detection device correspond to the switching state of the electromagnetic switching device 1.

Arranged in the housing 8 of the detection device 7 is a sensor device 14. The sensor device 14 is able to detect in which of the end positions the plunger 9 of the detection device 7 is located. An electrical signal E is able to be issued by the sensor device 14 which corresponds to the detected end position. The sensor device 14 in this case is embodied such that the position of the plunger 9 of the detection device 7 is able to be detected by it, without the plunger 9 touching the detection device 7. The sensor device 14 can typically be implemented as a Hall sensor.

The plunger 9, when viewed in a longitudinal direction x, features a central region 15 and two outer regions 16, 17 adjoining the central region 15. The outer regions 16, 17 consist of a non-magnetizable, injection-moldable material. The material of which the outer regions 16, 17 consists can especially be a plastic, for example a thermoplast or a duroplast.

Integrated into the central region 15 is a magnetic material. At least one section 18, 19 of the central region 15 is impressed with a defined magnetization.

In relation to the structure of the central region 15 there are different options. It is preferred that the central region 15 consists of an injection-moldable magnetizable material. In this case it is possible that the plunger 9, including the magnetizable material of which the central region 15 consists, is injection-molded by way of a two-component injection-molding method. Preferably the injection-moldable magnetizable material is a magnetizable plastic in this case.

Alternately however it is possible for the magnetizable material to be integrated into the central region 15 in another way. In this case the central region 15 typically consists of the same material as the outer regions 16, 17 with however the magnetizable material being inserted into the central region 15.

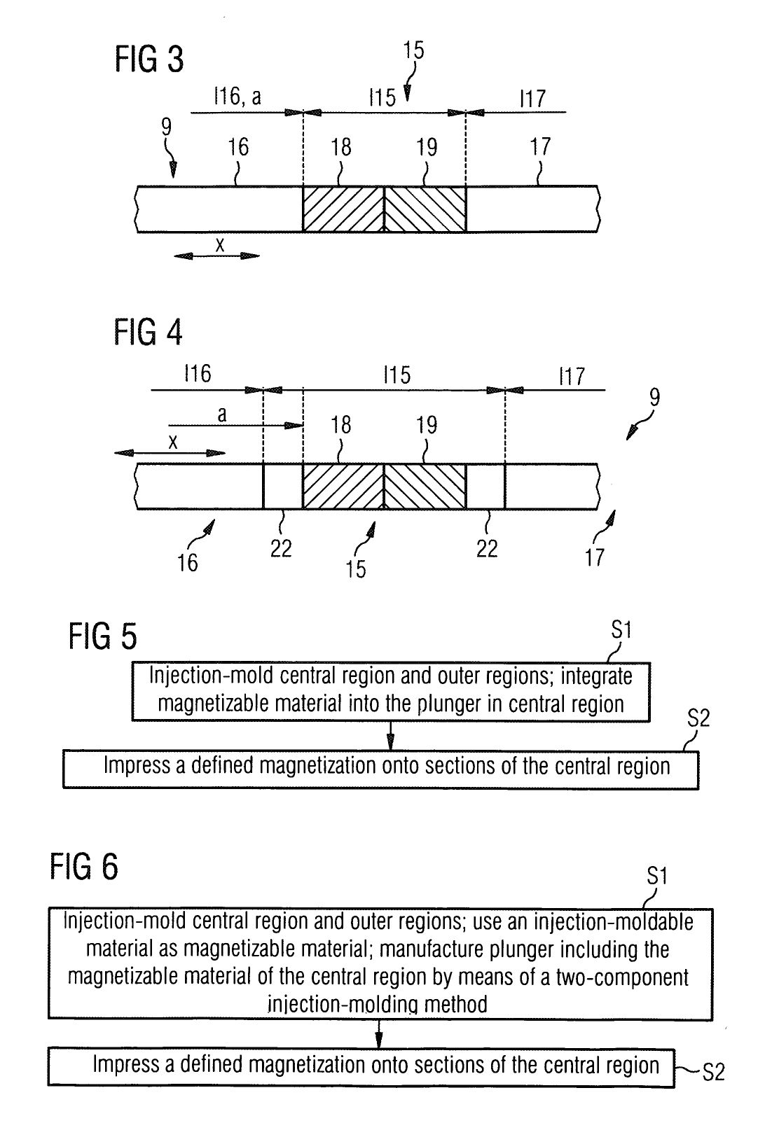

The at least one section 18, 19 should—in relation to the longitudinal direction x—be arranged at a predefined point. For example the at least one section 18, 19 should be at a defined distance a from one of the ends 20, 21 of the plunger 9. If it is possible to keep lengths 115, 116 and 117 of the central region 15 and of the outer regions 16, 17 exact enough as part of the manufacturing process, it is possible for the at least one section 18, 19 to be identical to the central region 15. This embodiment is shown in FIG. 3. Alternately it is possible for the at least one section 18, 19 to only extend over a part of the central region, i.e. at least a residual region 22 of the central region 15 remains onto which no magnetization is impressed. This embodiment is shown in FIG. 4.

Manufacturing methods for the plunger 9 are explained below in conjunction with FIG. 5 and FIG. 6. In this case FIG. 5 shows the inventive principle, FIG. 6 shows a preferred embodiment of this principle.

According to FIG. 5, in a step S1, the central region 15 and the outer regions 16, 17 of the plunger are injection-molded. Likewise within the framework of step S1, the magnetizable material is integrated into the plunger 9 within the framework of step S1. The magnetizable material in this case is either unmagnetized or unmagnetizable. In a step S2, i.e. only after the integration of the magnetizable material into the plunger 9, the sections 18, 19 of the central region 15 will be impressed with a defined magnetization.

FIG. 6 differs from FIG. 5 in the embodiment of step S1. According to FIG. 6 the central region 15 and the outer regions 16, 17 of the plunger 9 are likewise injection-molded within the framework of step S1. In the embodiment according to FIG. 6 however, an injection-moldable material is used as the magnetizable material. The plunger 9 can therefore be manufactured within the framework of step S1 of FIG. 6 including the magnetizable material of the central region 15 by means of a two-component injection-molding method. Step S2 in which the sections 18, 19 of the central region are impressed with the defined magnetization, is unchanged in relation to FIG. 5.

Embodiments of the present invention have many advantages. In particular it results in a simplified manufacturing of the plunger 9. Furthermore assembly errors (typically a reversed insertion of magnetizable elements into a prefabricated plunger) can be avoided. In addition the advantage is produced of a loosening or release of magnets being able to be avoided, even during long-term operation of the plunger 9. Finally the magnetized sections 18, 19 are protected against outside influences.

The above description serves exclusively to explain the present invention. The scope of protection of the present invention on the other hand is to be exclusively defined by the enclosed claims.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A manufacturing method for a plunger which, when viewed in a longitudinal direction has a central region and two outer regions adjoining the central region, the method comprising:
injection-molding the outer regions of the plunger from a non-magnetizable material and integrating a magnetizable material into the plunger in the central region; and
impressing a section of the central region with a defined magnetization after the integration of the magnetizable material into the plunger.

2. The manufacturing method as claimed in claim 1, wherein injection-moldable material is used as a magnetizable material and wherein the plunger including the magnetizable material is manufactured by way of a two-component injection-molding method.

3. The manufacturing method as claimed in claim 2, wherein injection-moldable magnetizable material is a magnetizable plastic.

4. The manufacturing method as claimed in claim 1, wherein the section is identical to the central region.

5. The manufacturing method as claimed in claim 1, wherein the section only extends over a part of the central region.

6. A plunger, comprising:
a central region, when viewed in a longitudinal direction;
two outer regions adjoining the central region,
the two outer regions of the plunger being injection-molded from a non-magnetizable material and the central region consisting of an injection-moldable magnetizable material, wherein the plunger, including the magnetizable material, is injection molded via a two-component injection-molding method, with a section of the central region being impressed with a defined magnetization.

7. The plunger as claimed in claim 6, wherein the injection-moldable, magnetizable material is a magnetizable plastic.

8. The plunger as claimed in claim 6, wherein the section is identical to the central region.

9. The plunger as claimed in claim 6, wherein the section only extends over a part of the central region.

10. The manufacturing method as claimed in claim 2, wherein the section is identical to the central region.

11. The manufacturing method as claimed in claim 2, wherein the section only extends over a part of the central region.

12. The manufacturing method as claimed in claim 3, wherein the section is identical to the central region.

13. The manufacturing method as claimed in claim 3, wherein the section only extends over a part of the central region.

14. The plunger as claimed in claim 7, wherein the section is identical to the central region.

15. The plunger as claimed in claim 7, wherein the section only extends over a part of the central region.
